(19) United States
(12) Patent Application Publication
(10) Pub. No.: US 2026/0295610 A1
(43) Pub. Date: Oct. 1, 2026

(54) ROTARY ATOMIZATION-TYPE COATING DEVICE AND ROTARY ATOMIZATION-TYPE COATING METHOD

(71) Applicant: NISSAN MOTOR CO., LTD., Yokohama-shi, Kanagawa (JP)

(72) Inventors: Shigenori KAZAMA, Kanagawa (JP); Tomoyuki KON, Kanagawa (JP); Makoto YAMADA, Kanagawa (JP); Takeshi GOTO, Kanagawa (JP)

(73) Assignee: NISSAN MOTOR CO., LTD., Yokohama-shi, Kanagawa (JP)

(21) Appl. No.: 19/489,847

(22) PCT Filed: Jun. 8, 2023
(86) PCT No.: PCT/JP2023/021324

§ 371 Date: Dec. 3, 2025

(51) Int. Cl. B05B 3/10

(52) U.S. Cl. CPC B05B 3/1092

(57) ABSTRACT

In order that the coating pattern of a coating material sprayed from a bell cup has a truncated cone shape, the disclosure includes: a bell cup (11) having a center of rotation (CL); a first air outlet (23) having an annular slit shape and provided concentrically with the center of rotation, the first air outlet blowing out inner shaping air (Sᵢₙ) from a back surface of the bell cup; and a second air outlet (24) having an annular slit shape and provided concentrically with the center of rotation, the second air outlet having a larger diameter than that of the first air outlet and blowing out outer shaping air (Sₒᵤₜ) from the back surface of the bell cup.

### TECHNICAL FIELD

The present invention relates to a rotary atomization-type coating device and a rotary atomization-type coating method.

### BACKGROUND ART

In a typical rotary atomization-type coating device, when the coating material is sprayed while shaping air is supplied from the back surface of a bell cup, a doughnut-shaped coating pattern (also called a spray pattern) is formed with a circular hole in the center. When the coating device including the bell cup is moved relative to the coating target with this doughnut-shaped coating pattern, the amount of coating material applied in the direction perpendicular to the movement direction, that is, the film thickness distribution of the coating film, becomes uneven, which may be problematic. To address this problem, it has been proposed to change the form of coating pattern sprayed from the bell cup into an elliptical coating pattern (Patent Document 1).

### PRIOR ART DOCUMENTS

### Patent Documents

Patent Document 1: JP60-54754A

### SUMMARY OF INVENTION

### Problems to be solved by Invention

However, while changing the form of coating pattern into an elliptical one as in the above prior art eliminates the central circular hole, the area of the coating pattern decreases. This requires either increasing the number of coats or increasing the gun distance by increasing the amount of coating material discharged. The former results in a new problem of reduced productivity, while the latter results in a new problem of reduced atomization of the coating material. To avoid these new problems, therefore, it is desired to change the doughnut-shaped coating pattern to a truncated cone-shaped coating pattern (one in which the film thickness distribution in the direction perpendicular to the direction of movement is trapezoidal).

A problem to be solved by the present invention is to provide rotary atomization-type coating device and method that result in a truncated cone-shaped coating pattern.

### Means for Solving Problems

The present invention solves the above problem through,
when rotating a bell cup around its center of rotation while supplying a coating material to a coating material diffusion surface of the bell cup and atomizing and applying the coating material using the bell cup,
blowing out inner shaping air in an annular slit shape from a back surface of the bell cup, concentric with the center of rotation, and concurrently blowing out outer shaping air in an annular slit shape from the back surface of the bell cup, concentric with the center of rotation and at a position with a larger diameter than the inner shaping air.

### Effect of Invention

According to the present invention, the coating pattern of the coating material sprayed from the bell cup is in the shape of a truncated cone.

### BRIEF DESCRIPTION OF DRAWINGS

FIG. 1 is a cross-sectional view illustrating an embodiment of the rotary atomization-type coating device according to the present invention.

FIG. 2 is a cross-sectional view illustrating another embodiment of the rotary atomization-type coating device according to the present invention.

FIG. 3 is a diagram illustrating the situation of airflow generated in front of a bell cup (no shaping air).

FIG. 4A is a diagram illustrating the situation of airflow generated in front of the bell cup (inner shaping air alone).

FIG. 4B is a diagram illustrating the situation of airflow generated in front of the bell cup (inner shaping air alone, increased flow rate).

FIG. 4C is a diagram illustrating the film thickness distribution when only inner shaping air is supplied.

FIG. 5A is a diagram illustrating the situation of airflow generated in front of the bell cup (outer shaping air alone).

FIG. 5B is a diagram illustrating the situation of airflow generated in front of the bell cup (outer shaping air alone, increased flow rate).

FIG. 5C is a diagram illustrating the film thickness distribution when only outer shaping air is supplied.

FIG. 6A is a diagram illustrating the situation of airflow generated in front of the bell cup (both inner and outer shaping air).

FIG. 6B is a diagram illustrating the film thickness distribution when both inner and outer shaping air are supplied.

FIG. 7A is a diagram illustrating the film thickness distribution of Comparative Example 1 in which the first air outlet from which the inner shaping air is blown out is configured with a plurality of holes in place of a slit shape.

FIG. 7B is a diagram illustrating the film thickness distribution of Comparative Example 2 in which the second air outlet from which the outer shaping air is blown out is configured with a plurality of holes in place of a slit shape.

### MODE(S) FOR CARRYING OUT INVENTION

### First Embodiment

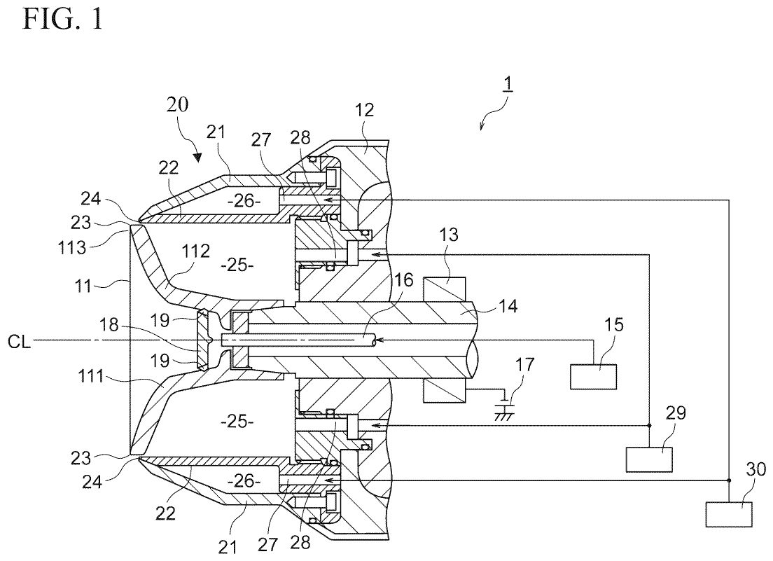

An example of a mode for carrying out the present invention will now be described with reference to the drawings. FIG. 1 is a cross-sectional view illustrating the tip portion of a rotary atomization-type coating device 1 according to an embodiment of the present invention. The rotary atomization-type coating device 1 of the present embodiment illustrated in the figure has a housing 12 formed of an electrically insulating material, in which a hollow shaft 14 is provided to be rotatable about a center of rotation CL. The hollow shaft 14 is driven to rotate by an air motor 13, and a bell cup 11 that sprays the coating material is fixed to the tip of the hollow shaft 14 by means of screw fastening or the like. The bell cup 11 is also referred to as an atomizing head or spray head, but will be referred to as a bell cup in the present specification. The bell cup 11 is driven to rotate together with the hollow shaft 14 about the center of rotation CL. A non-rotating feed tube 16 is disposed in the central hole of the hollow shaft 14, and supplies the bell cup 11 with the coating material and cleaning thinner from a coating material supply device 15.

The rotary atomization-type coating device 1 of the present embodiment allows the coating material particles charged by a high-voltage power supply 17 to fly along the electrostatic field formed between the coating device and the coating target, depositing the coating material on the coating target. The coating target is located on the left side of FIG. 1, separated by a predetermined gun distance, and is grounded via a conductive member that holds the coating target, such as a coating cart or coating hanger. As illustrated in FIG. 1, the high-voltage application scheme can be an internal application type, in which the high-voltage power supply 17 is provided in the housing 12 and applies the voltage to the bell cup 11 composed of a conductive material via the hollow shaft 14 also composed of a conductive material. Alternatively, when using a water-based coating material, the electrostatic coating device can be provided as an external application type one, in which a discharge electrode connected to a high-voltage power supply is provided around the bell cup 11 to apply the voltage to the coating material particles flying out of the bell cup 11.

The tip of the feed tube 16 is exposed from the tip of the hollow shaft 14 and extends toward the inside of the bell cup 11. This feed tube 16 is supplied with the coating material or cleaning thinner from the coating material supply device 15, and the coating material or cleaning thinner is supplied from the tip of the feed tube 16 onto a coating material diffusion surface 111 of the bell cup 11. The cleaning thinner is a cleaning liquid (organic solvent for organic solvent-based coating materials, or water for water-based coating materials) for cleaning the coating material diffusion surface 111 of the bell cup 11 and a hub 18 to be described later. When the rotary atomization-type coating device 1 of the present embodiment is applied to a topcoat or intermediate coating process that requires a color change, the cleaning thinner is supplied for cleaning when changing the coating material color. Accordingly, in a coating process that does not require a color change, such as an intermediate coating process in which only a single intermediate coating material is applied, only the coating material may be supplied to the feed tube 16. The color change is performed by a color change valve unit such as a color change valve (not illustrated) included in the coating material supply device 15.

The bell cup 11 is approximately cup-shaped and, in this example, is formed from a conductive material such as metal. The bell cup 11 has the coating material diffusion surface 111 on the cup-shaped inner surface, a cup-shaped outer surface 112, and a tip edge 113 located at the tip of the inner surface from which the coating material is released. The hub 18 is attached to the center of the base end side of the bell cup 11 and at the tip of the feed tube 16. This hub 18 can be composed of any of a conductive material such as metal and an electrically insulating material such as plastic. The hub 18 may be attached to the tip of the hollow shaft 14 or the base end of the bell cup 11 so that it rotates with the hollow shaft 14 and the bell cup 11, or may also be attached to the tip of the feed tube 16 so that it does not rotate. The bell cup 11 can also be composed of an electrically insulating material.

Since the bell cup 11 is circular when viewed from the front, the hub 18 is also circular when viewed from the front. A plurality of coating material discharge holes 19 are formed at predetermined intervals around the outer peripheral portion of the hub 18, and the coating material or cleaning thinner supplied from the tip of the feed tube 16 passes through the coating material discharge holes 19 of the hub 18 and is guided to the coating material diffusion surface 111 of the bell cup 11, on which the coating material or cleaning thinner is scattered from the entire circumference of the tip edge 113 by centrifugal force.

To deflect the coating material particles atomized by the bell cup 11 toward the coating target located ahead of the bell cup 11, shaping air is supplied from the back surface side of the bell cup 11. In the rotary atomization-type coating device 1 of the present embodiment, inner shaping air Sᵢₙ is blown out from the back surface of the bell cup 11 in an annular slit shape, concentric with the center of rotation CL, while outer shaping air Sₒᵤₜ, larger in diameter than the inner shaping air Sᵢₙ and concentric with the center of rotation CL, is blown out in an annular slit shape.

To this end, an air ring 20 is provided at the tip portion of the housing 12 so as to be concentric with the center of rotation CL and surround the bell cup 11. The air ring 20 is formed by assembling an outer ring 21 and an inner ring 22, each composed of a conductive or electrically insulating material, and the tip at which the outer ring 21 and inner ring 22 are assembled forms an annular slit-shaped second air outlet 24. In addition, an annular second semi-enclosed space 26 is formed within the assembled outer ring 21 and inner ring 22, and a plurality of through-holes 27 are formed at predetermined intervals on the base end side of the annular second semi-enclosed space 26. When air is supplied to these through-holes 27 from a second air supply device 30, the outer shaping air Sₒᵤₜ is blown out from the annular slit-shaped second air outlet 24 formed at the tip of the air ring 20.

On the other hand, the air ring 20 of this example is provided so that a small gap separates the inner ring 22 of the air ring 20 from the bell cup 11, thereby forming an annular slit-shaped gap between the tip of the inner ring 22 and the tip edge 113 of the bell cup 11. In the present embodiment, this annular slit-shaped gap serves as a first air outlet 23 for blowing out the inner shaping air Sᵢₙ. In addition, a first semi-enclosed space 25 is formed between the inner circumferential surface of the inner ring 22, an outer surface 112 of the bell cup 11, and the housing 12, and a plurality of through-holes 28 are formed at predetermined intervals on the base end side of the first semi-enclosed space 25. When air is supplied to these through-holes 28 from a first air supply device 29, the inner shaping air Sᵢₙ is blown out from the annular slit-shaped first air outlet 23 formed between the inner ring 22 of the air ring 20 and the bell cup 11.

By appropriately adjusting the flow rates of the inner shaping air Sᵢₙ blown out from the first air outlet 23 and the outer shaping air Sₒᵤₜ blown out from the second air outlet 24, it is possible to control the flight direction of the coating material particles flying out tangentially of the tip of the bell cup 11, that is, to control the coating pattern. Furthermore, the coating material particles are imparted with momentum by these shaping airs in addition to the force due to the above-described electrostatic field.

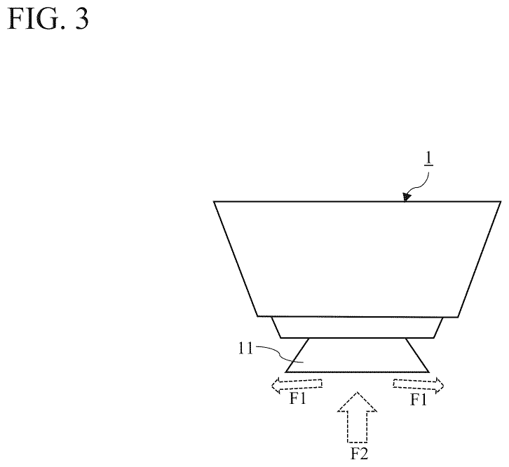

Here, with reference to FIGS. 3 to 7B, the actions of inner shaping air Sᵢₙ and outer shaping air Sₒᵤₜ will be described based on experimental data.

FIG. 3 is a diagram illustrating the airflow generated in front of the bell cup 11, which illustrates the case in which no shaping air is supplied. In this case, as the bell cup 11 rotates at high speed, air on the surface of the bell cup 11 is dragged, generating airflow F1 that flows radially outward. Furthermore, since the airflow F1 is generated, air in front of the bell cup 11 is drawn toward the bell cup 11, generating airflow F2.

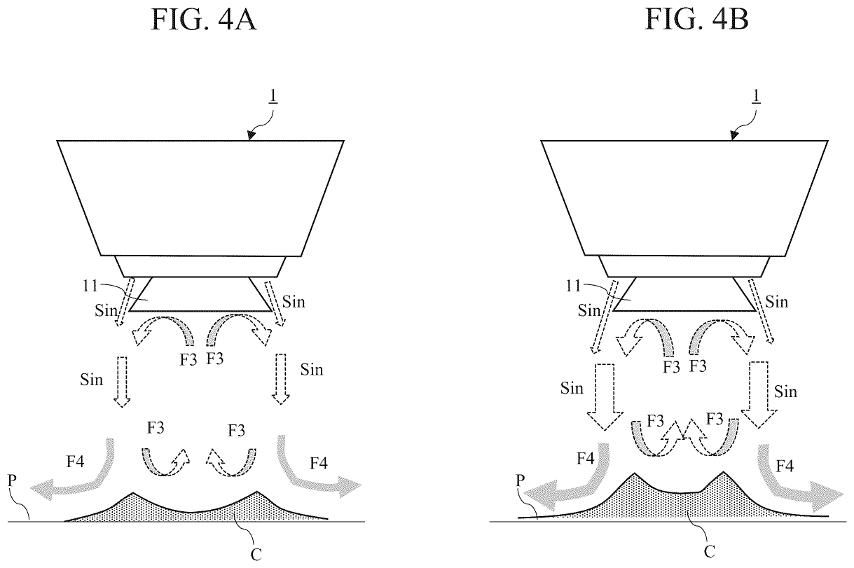

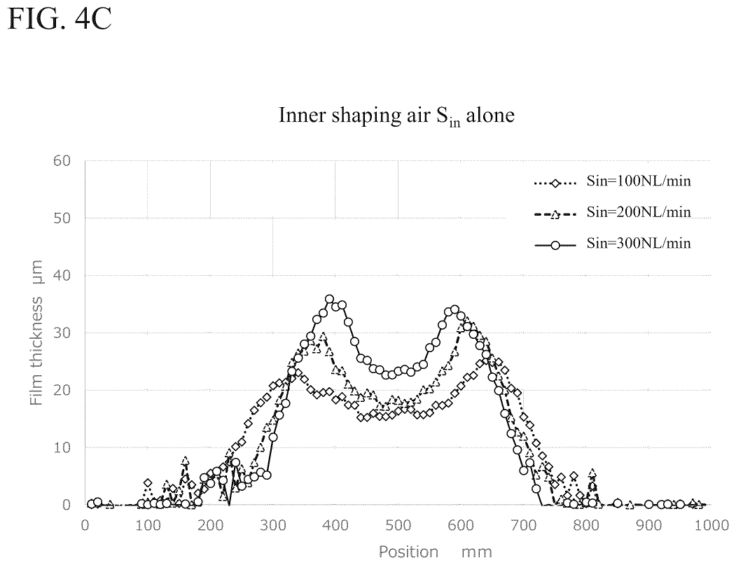

FIG. 4A is a diagram illustrating the airflow generated in front of the bell cup 11, which illustrates the case in which only the inner shaping air Sᵢₙ is supplied. FIG. 4B illustrates the case in which the air flow rate is increased also when only the inner shaping air Sᵢₙ is supplied. As illustrated in FIG. 4A, when the inner shaping air Sᵢₙ is blown out from the back surface of the bell cup 11, the airflow (F1 in FIG. 3) flowing radially outward from the bell cup 11 merges with the inner shaping air Sᵢₙ, and generates a circulating airflow F3 between the bell cup 11 and the surface of the coating target P. After colliding with the surface of the coating target P, the inner shaping air Sᵢₙ becomes excess airflow F4 and diffuses to the surroundings. In this case, the cross-section of a coating film C takes on a two-humped camel shape with a central depression.

If the flow rate of the inner shaping air Sᵢₙ is increased from the state illustrated in FIG. 4A, the circulating airflow F3 increases as illustrated in FIG. 4B, and the coating material particles begin to concentrate slightly toward the center. In this case, the cross-section of the coating film C remains a two-humped camel shape with a central depression, but the distance between the two raised portions becomes slightly narrower. The inner shaping air Sᵢₙ is blown out along the back surface of the bell cup 11, and therefore an outward velocity component inevitably occurs. For this reason, increasing the flow rate does not have much effect on improving the two-humped camel-shaped distribution, but it does have the effect of increasing the circulating air flow F3 in front of the bell cup 11, resulting in an effect of concentrating the entire pattern toward the center.

FIG. 4C is a diagram illustrating the film thickness distribution when only the inner shaping air Sᵢₙ is supplied as illustrated in FIGS. 4A and 4B. In FIG. 4C, the horizontal axis represents the surface position on the coating target P and the vertical axis represents the film thickness of the coating film C. The film thickness distribution when only the inner shaping air Sᵢₙ is supplied becomes a two-humped camel-shaped distribution with a central depression as illustrated in FIG. 4C. As the air flow rate is increased, the coating material particles congregate toward the center, but the two-humped camel shape with a central depression remains. Furthermore, the width of the coating pattern is approximately 550 to 600 mm, and little variation in the width of the coating pattern with changes in the air flow rate is observed.

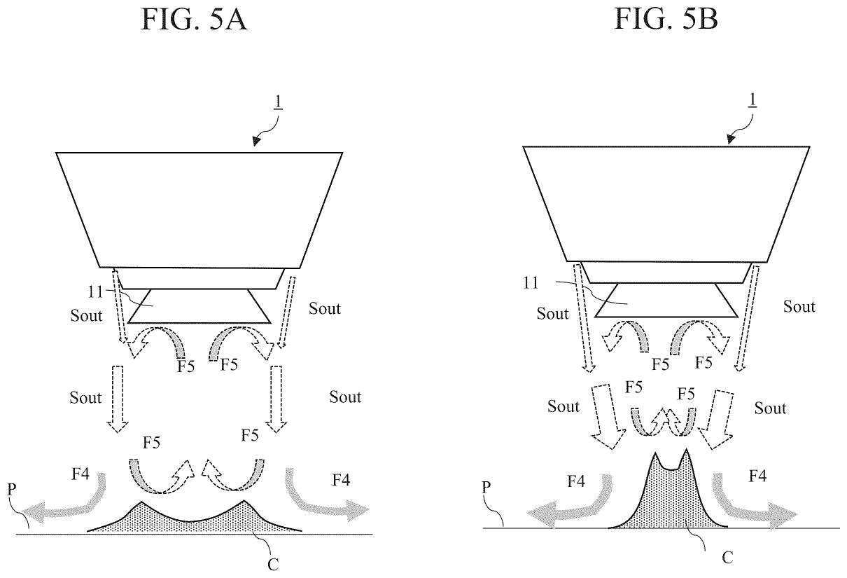

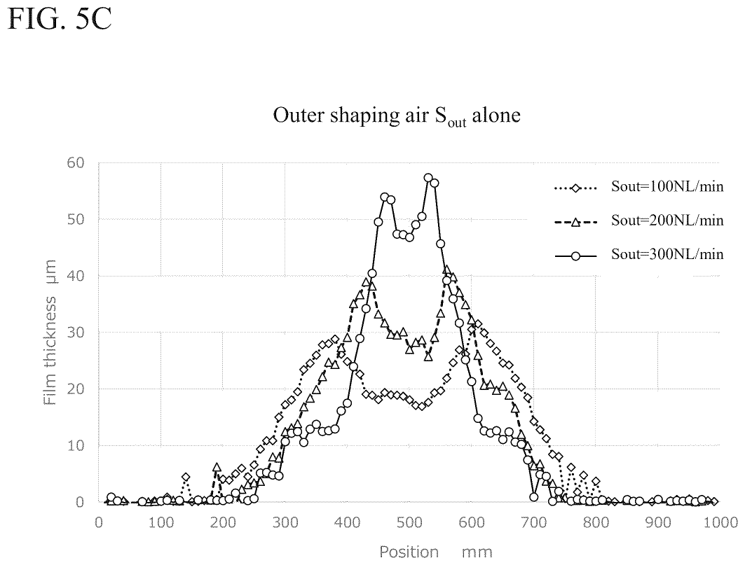

FIG. 5A is a diagram illustrating the airflow generated in front of the bell cup 11, which illustrates the case in which only the outer shaping air Sₒᵤₜ is supplied. FIG. 5B illustrates the case in which the air flow rate is increased also when only the outer shaping air Sₒᵤₜ is supplied. As illustrated in FIG. 5A, when the outer shaping air Sₒᵤₜ is blown out from the back surface of the bell cup 11, this outer shaping air Sₒᵤₜ is blown out from the outside of the first air outlet 23 of the inner shaping air Sᵢₙ at an angle of targeting the bell edge of the bell cup 11, generating a velocity component toward the central axis of the bell cup 11. This outer shaping air Sₒᵤₜ and the airflow (F1 in FIG. 3) directed radially outward from the bell cup 11 merge and generate a circulating airflow F5 between the bell cup 11 and the surface of the coating target P. After colliding with the surface of the coating target P, the outer shaping air Sₒᵤₜ becomes excess airflow F4 and diffuses to the surroundings. In this case, the cross section of the coating film C has a two-humped camel shape with a central depression, but the spacing between the raised portions is slightly smaller than in the cross-sectional shape of FIG. 4A.

If the flow rate of the outer shaping air Sₒᵤₜ is increased from the state of FIG. 5A, the velocity component toward the central axis of the bell cup 11 increases as illustrated in FIG. 5B, and the apexes of the two-humped camel shape become extremely centered. However, because the outer shaping air Sₒᵤₜ has an extreme effect of centering the apexes of the two-humped camel shape, the cross section of the coating film C has a sharp distribution that is roughly triangular, as illustrated in FIG. 5B.

FIG. 5C is a diagram illustrating the film thickness distribution when only the outer shaping air Sₒᵤₜ is supplied as illustrated in FIGS. 5A and 5B. In FIG. 5C, the horizontal axis represents the surface position on the coating target P and the vertical axis represents the film thickness of the coating film C. The film thickness distribution when only the outer shaping air Sₒᵤₜ is supplied becomes a two-humped camel-shaped distribution with a central depression as illustrated in FIG. 5C. As the air flow rate is increased, the coating material particles congregate toward the center, but the two-humped camel shape with a central depression remains. Furthermore, the width of the coating pattern is approximately 550 to 600 mm, and it can be seen that while fluctuations in the air flow rate cause large fluctuations in the film thickness in the center, the width of the coating pattern is not significantly affected.

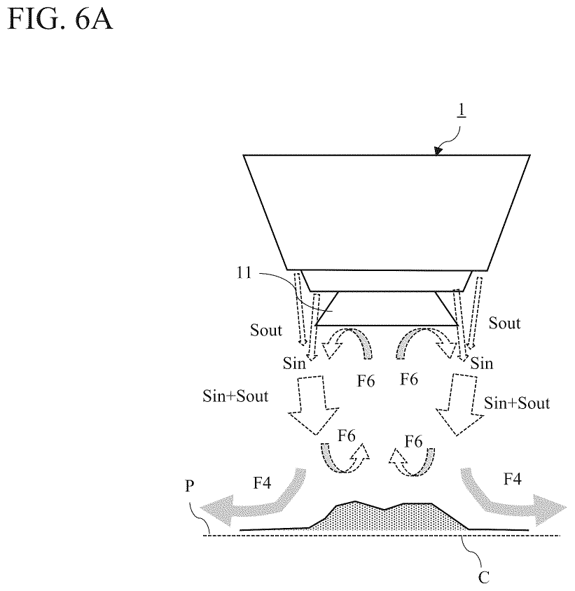

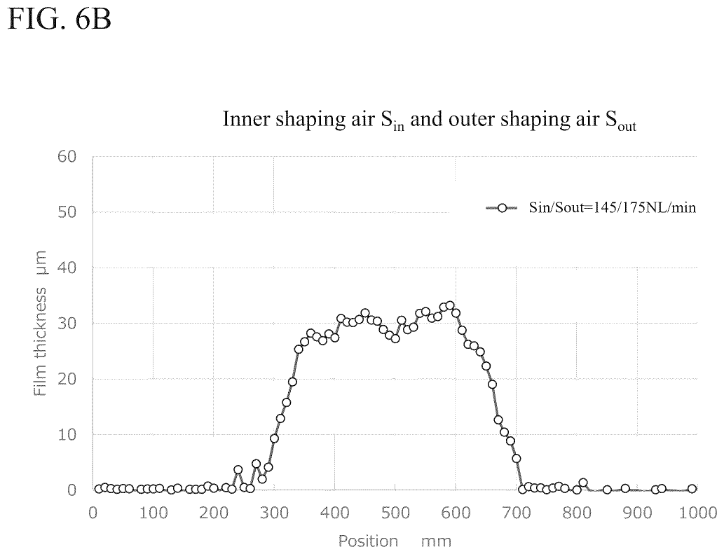

FIG. 6A is a diagram illustrating the situation of airflow generated in front of the bell cup 11, which illustrates the case in which both the inner shaping air Sᵢₙ and the outer shaping air Sₒᵤₜ are supplied. As illustrated in FIG. 6A, when the inner shaping air Sᵢₙ and the outer shaping air Sₒᵤₜ are simultaneously blown out from the back surface of the bell cup 11, the airflow (F1 in FIG. 3) flowing radially outward from the bell cup 11 merges with the inner shaping air Sᵢₙ and the outer shaping air Sₒᵤₜ, generating a circulating airflow F6 between the bell cup 11 and the surface of the coating target P. This circulating airflow F6 allows the circulating airflow F3 generated by the inner shaping air Sᵢₙ illustrated in FIG. 4A to center the entire pattern, while the circulating airflow F5 generated by the outer shaping air Sₒᵤₜ illustrated in FIG. 5A can center the apexes of the two-humped camel. The coating material particles are therefore appropriately centered while maintaining the pattern width. Furthermore, after colliding with the surface of the coating target P, the outer shaping air Sₒᵤₜ becomes excess airflow F4 and diffuses to the surroundings. In this case, the cross section of the coating film C has a trapezoidal shape with no central depression.

FIG. 6B is a diagram illustrating the film thickness distribution when both the inner shaping air Sᵢₙ and the outer shaping air Sₒᵤₜ are supplied as illustrated in FIG. 6A (inner shaping air Sᵢₙ flow rate: 145 NL/min, outer shaping air Sₒᵤₜ flow rate: 175 NL/min). In FIG. 6B, the horizontal axis represents the position on the surface of the coating target P, and the vertical axis represents the film thickness of the coating film C. As illustrated in FIG. 6B, in the film thickness distribution when both the inner shaping air Sᵢₙ and the outer shaping air Sₒᵤₜ are supplied, the width of the coating pattern is approximately 400 mm, and the film thickness distribution of the coating pattern rises sharply toward the center to form the side surface of a truncated cone. In addition, the film thickness in the central portion of the coating pattern is almost flat, and the width of the flat portion expands to approximately 250 mm.

As described above, in the rotary atomization-type coating device 1 of the present embodiment, the inner shaping air Sᵢₙ is blown out in an annular slit shape from the back surface of the bell cup 11 and the outer shaping air Sₒᵤₜ is concurrently blown out in an annular slit shape from the back surface of the bell cup 11, so that a truncated cone-shaped coating pattern can be obtained with a trapezoidal film thickness distribution in the direction perpendicular to the direction of movement.

In the rotary atomization-type coating device 1 of the present embodiment, although not particularly limited, it is preferred that the flow rate of the outer shaping air Sₒᵤₜ should be equal to or greater than the flow rate of the inner shaping air Sᵢₙ. Such a flow rate allocation allows the outer shaping air Sₒᵤₜ to shield the mixed gas of the inner shaping air Sᵢₙ and atomized coating material particles so that the mixed gas fills the front of the bell cup 11, and a coating pattern can be obtained with a truncated cone-shaped film thickness distribution that is steep around the periphery and flat in the center.

In the rotary atomization-type coating device 1 of the present embodiment, although not particularly limited, it is preferred that the flow velocity of the outer shaping air Sₒᵤₜ should be equal to or greater than the flow velocity of the inner shaping air Sᵢₙ. Such a flow velocity allocation can create a coating pattern with a film thickness distribution in which both tails are steep and the central portion is flat.

In the rotary atomization-type coating device 1 of the present embodiment, although not particularly limited, it is preferred that the ratio of the opening cross-sectional area of the annular slit-shaped first air outlet 23 to the opening cross-sectional area of the annular slit-shaped second air outlet 24 should be 3:1 to 4:1. Such an opening cross-sectional area allocation can create a coating pattern with a film thickness distribution in which both tails are steep and the central portion is flat.

In the rotary atomization-type coating device 1 of the present embodiment, although not particularly limited, it is preferred that the distance between the tip of the inner circumferential surface of the air ring 20 and the tip of the bell cup 11 should not exceed 2 mm.

In the rotary atomization-type coating device 1 of the present embodiment, although not particularly limited, it is preferred that the inner shaping air Sᵢₙ should be non-directional with respect to the circumferential direction of the first air outlet 23. Being non-directional with respect to the circumferential direction of the first air outlet 23 means that the blowing direction of the inner shaping air Sᵢₙ is not inclined circumferentially, and air is blown out along the direction of the center of rotation CL of the bell cup 11.

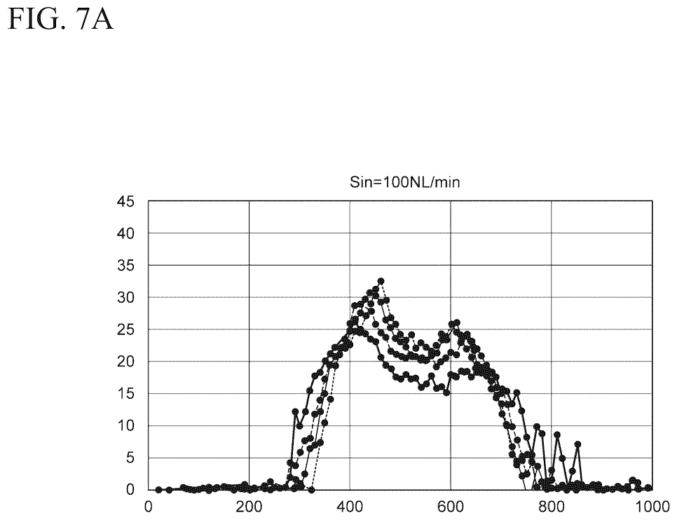

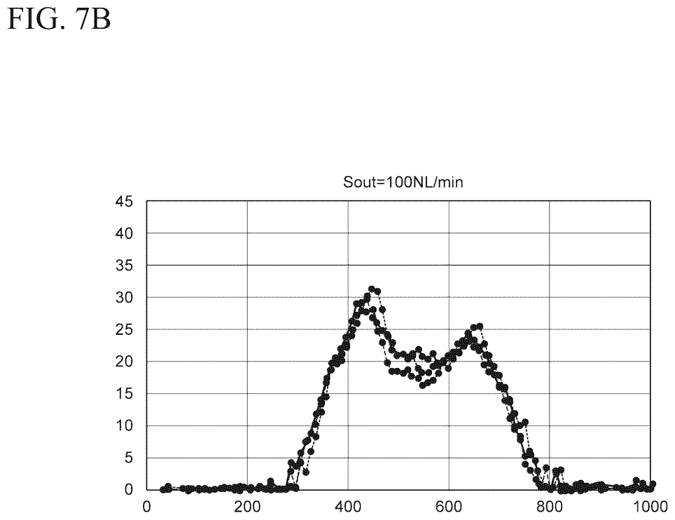

FIG. 7A is a diagram illustrating the film thickness distribution of Comparative Example 1, in which the first air outlet 23 from which the inner shaping air Sᵢₙ is blown is configured with a plurality of holes in place of a slit shape, and FIG. 7B is a diagram illustrating the film thickness distribution of Comparative Example 2, in which the second air outlet 24 from which the outer shaping air Sₒᵤₜ is blown is configured with a plurality of holes in place of a slit shape. In both Comparative Examples 1 and 2, the film thickness distribution is not symmetrical about the center of the bell cup 11. This is because the holes in Comparative Examples 1 and 2 are formed at an angle in the circumferential direction, and the shaping air blown out from these holes has circumferential directionality. In contrast, in the rotary atomization-type coating device 1 of the present embodiment, the film thickness distribution is symmetrical about the center of the bell cup 11, as illustrated in FIG. 6B.

### Second Embodiment

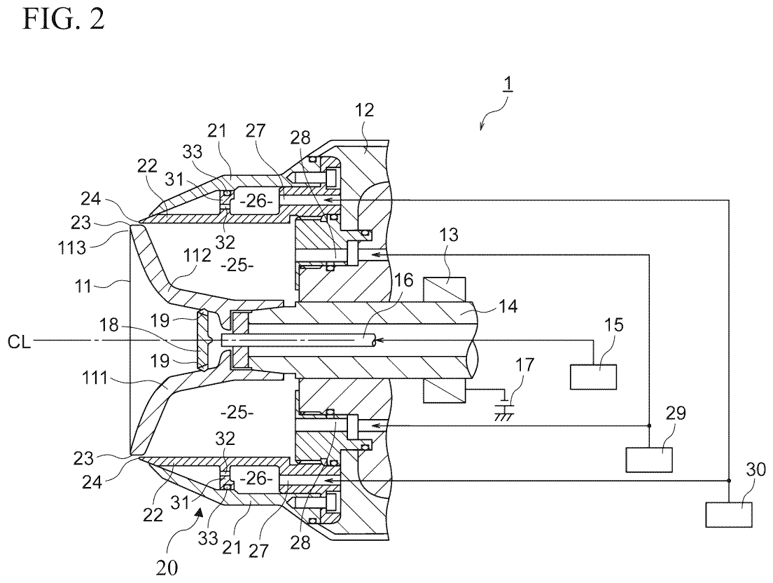

FIG. 2 is a cross-sectional view illustrating another embodiment of the rotary atomization-type coating device according to the present invention. The rotary atomization-type coating device 1 according to the embodiment illustrated in FIG. 2 differs partially from the rotary atomization-type coating device 1 according to the embodiment illustrated in FIG. 1 in the configuration of the air ring 20. Other configurations are the same as those of the rotary atomization-type coating device 1 of the embodiment illustrated in FIG. 1, so the same configurations are denoted by the same reference numerals and the descriptions are borrowed herein.

As in the rotary atomization-type coating device 1 of the embodiment illustrated in FIG. 1, the air ring 20 of the present embodiment is provided at the tip portion of the housing 12 so as to be concentric with the center of rotation CL and surround the bell cup 11. The air ring 20 of the present embodiment is also formed by assembling an outer ring 21 and an inner ring 22, each composed of a conductive or electrically insulating material, and the tip at which the outer ring 21 and inner ring 22 are assembled forms an annular slit-shaped second air outlet 24. In addition, an annular second semi-enclosed space 26 is formed within the assembled outer ring 21 and inner ring 22, and a plurality of through-holes 27 are formed at predetermined intervals on the base end side of the annular second semi-enclosed space 26.

However, unlike the air ring 20 of the embodiment illustrated in FIG. 1, in the air ring 20 of the present embodiment, a partition wall 31 that circumferentially divides the second semi-enclosed space 26 is provided integrally with the inner ring 22. This circumferentially extending partition wall 31 is provided with a plurality of through-holes 32 in a discrete form, and an elastic seal member 33 is interposed between the partition wall 31 and the outer ring 21. The sum of the cross-sectional areas of the plurality of through-holes 32 is set to be larger than the opening cross-sectional area of the tip of the second air outlet 24. When air is supplied from the second air supply device 30 to the through-holes 27, the air is rectified by the plurality of through-holes 32 formed in the partition wall 31 and then reaches the second air outlet 24, which has an annular slit shape and is formed at the tip of the air ring 20, and the outer shaping air Sₒᵤₜ is blown out from the second air outlet 24.

Furthermore, unlike the air ring 20 of the embodiment illustrated in FIG. 1, in the air ring 20 of the present embodiment, the tip of the outer ring 21 is provided at a back position of the tip of the inner ring 22 as illustrated in FIG. 2. With this configuration, although the flow rate of the outer shaping air Sₒᵤₜ increases slightly, the responsibility of the coating pattern distribution to fluctuations in the flow rate of the outer shaping air Sₒᵤₜ is reduced, and the coating pattern is stabilized. In addition, since the tip of the outer ring 21 is set back from the tip of the inner ring 22, occlusion of the second air outlet 24 by coating material mist can be easily found visually.

As described above, the rotary atomization-type coating device 1 of the present embodiment includes: a bell cup 11 having a center of rotation CL; a first air outlet 23 having an annular slit shape and provided concentrically with the center of rotation CL, the first air outlet 23 blowing out inner shaping air Sᵢₙ from a back surface of the bell cup 11; and a second air outlet 24 having an annular slit shape and provided concentrically with the center of rotation CL, the second air outlet 24 having a larger diameter than that of the first air outlet 23 and blowing out outer shaping air Sₒᵤₜ from the back surface of the bell cup 11. This allows for a truncated cone-shaped coating pattern with steep peripheral sides and a flat center. As a result, a coating film with a uniform thickness distribution can be obtained even with a small number of recoats. In addition, the coating speed can be reduced, for example, to 600 mm/sec or less, and the coating efficiency of the coating material is therefore improved.

Moreover, according to the rotary atomization-type coating device 1 of the present embodiment, the inner shaping air Sᵢₙ is non-directional with respect to the circumferential direction of the first air outlet 23, and the central flat portion of the truncated cone-shaped coating pattern can therefore be made symmetrical.

Furthermore, according to the rotary atomization-type coating device 1 of the present embodiment, the flow rate of the outer shaping air Sₒᵤₜ is equal to or greater than that of the inner shaping air Sᵢₙ, which allows the outer shaping air Sₒᵤₜ to shield the mixed gas of the inner shaping air Sᵢₙ and atomized coating material particles so that the mixed gas fills the front of the bell cup 11. This allows the coating pattern to be obtained with a truncated cone-shaped film thickness distribution that is steep at the peripheral sides and flat in the center.

In addition, according to the rotary atomization-type coating device 1 of the present embodiment, the ratio of the opening cross-sectional area of the first air outlet 23 to the opening cross-sectional area of the second air outlet 24 is 3:1 to 4:1, and it is therefore possible to obtain a truncated cone-shaped coating pattern with steep peripheral sides and a flat center.

Moreover, according to the rotary atomization-type coating device 1 of the present embodiment, it further comprises an air ring 20 provided concentrically with the center of rotation CL to surround the bell cup 11, wherein the second air outlet 24 is formed at the tip of the air ring 20, an annular slit-shaped gap between the tip of the inner circumferential surface of the air ring 20 and the tip of the bell cup 11 serves as the first air outlet 23, and source air that becomes the inner shaping air Sᵢₙ is supplied to the first semi-enclosed space 25 between the inner circumferential surface of the air ring 20 and the back surface of the bell cup 11. Therefore, the first air outlet 23 can be configured with a simple structure. In addition, the airflow drawn in by the inner shaping air Sᵢₙ can suppress the accumulation of coating material mist adhering to the outer surface of the bell cup 11.

Furthermore, according to the rotary atomization-type coating device 1 of the present embodiment, the distance between the tip of the inner circumferential surface of the air ring 20 and the tip of the bell cup 11 does not exceed 2 mm, and the first air outlet 23 can therefore be configured with a simple structure.

In addition, according to the rotary atomization-type coating device 1 of the present embodiment, the air ring 20 includes: a second semi-enclosed space 26 to which the source air that becomes the outer shaping air Sₒᵤₜ is supplied; a partition wall 31 that circumferentially divides the second semi-enclosed space 26; and a plurality of through-holes 32 provided in the partition wall 31, and the sum of cross-sectional areas of the through-holes 32 is greater than an opening cross-sectional area of the tip of the second air outlet 24. Therefore, when air is supplied from the second air supply device 30 to the through-holes 27, this air is rectified by the plurality of through-holes 32 formed in the partition wall 31. This rectified air then reaches the annular slit-shaped second air outlet 24 formed at the tip of the air ring 20, from which the outer shaping air Sₒᵤₜ is blown out. That is, by providing the partition wall 31 having the plurality of through-holes 32, uniformity of the gap of the annular slit-shaped second air outlet 24 can be ensured. In addition, by providing the plurality of through-holes 32, the flow rate of air supplied to the second air outlet 24 can be made uniform.

Moreover, according to the rotary atomization-type coating device 1 of the present embodiment, the air ring 20 is formed by assembling an outer ring 21 and an inner ring 22, the partition wall 31 is integrally formed with the inner ring 22, and an elastic seal member 33 is interposed between the partition wall 31 and the outer ring 21. It is therefore possible to suppress the axial misalignment when assembling the outer ring 21 and inner ring 22. In addition, since the partition wall 31 extends in the circumferential direction, the opening of the second air outlet 24 is highly rigid, and vibrations caused by the flow rate of the outer shaping air Sₒᵤₜ can be absorbed by deformation of the elastic seal member 33.

Furthermore, according to the rotary atomization-type coating device 1 of the present embodiment, since the tip of the outer ring 21 is provided at a back position of the tip of the inner ring 22, the flow rate of the outer shaping air Sₒᵤₜ increases slightly, but the responsibility of the coating pattern distribution to fluctuations in the flow rate of the outer shaping air Sₒᵤₜ is reduced, and the coating pattern is stabilized. In addition, since the tip of the outer ring 21 is set back from the tip of the inner ring 22, occlusion of the second air outlet 24 by coating material mist can be easily found visually.

### DESCRIPTION OF REFERENCE NUMERALS

1 . . . Rotary atomization-type coating device
11 . . . Bell cup
CL . . . Center of rotation
111 . . . Coating material diffusion surface
112 . . . Outer surface
113 . . . Tip edge
12 . . . Housing
13 . . . Air motor
14 . . . Hollow shaft
15 . . . Coating material supply device
16 . . . Feed tube
17 . . . High-voltage power supply
18 . . . Hub
19 . . . Coating material discharge hole
20 . . . Air ring
21 . . . Outer ring
22 . . . Inner ring
23 . . . First air outlet
24 . . . Second air outlet
25 . . . First semi-enclosed space
26 . . . Second semi-enclosed space
27, 28 . . . Through-hole
29 . . . First air supply device
30 . . . Second air supply device
31 . . . Partition wall
32 . . . Through-hole
33 . . . Elastic sealing member

1.-10. (canceled)

11. A rotary atomization-type coating device comprising:
a bell cup having a center of rotation;
a first air outlet having an annular slit shape and provided concentrically with the center of rotation, the first air outlet blowing out inner shaping air from a back surface of the bell cup; and
a second air outlet having an annular slit shape and provided concentrically with the center of rotation, the second air outlet having a larger diameter than that of the first air outlet and blowing out outer shaping air from the back surface of the bell cup, wherein a ratio of an opening cross-sectional area of the first air outlet to that of the second air outlet is 3:1 to 4:1.

12. The rotary atomization-type coating device according to claim 11, further comprising
an air ring provided concentrically with the center of rotation to surround the bell cup, the second air outlet being formed at a tip of the air ring,
wherein
an annular slit-shaped gap between the tip of an inner circumferential surface of the air ring and a tip of the bell cup serves as the first air outlet, and
source air that becomes the inner shaping air is supplied to a semi-enclosed space between the inner circumferential surface of the air ring and the back surface of the bell cup.

13. The rotary atomization-type coating device according to claim 11, wherein the inner shaping air is non-directional with respect to a circumferential direction of the first air outlet.

14. The rotary atomization-type coating device according to claim 12, wherein a distance between the tip of the inner circumferential surface of the air ring and the tip of the bell cup does not exceed 2 mm.

15. The rotary atomization-type coating device according to claim 12, wherein the air ring comprises:
a semi-enclosed space to which the source air that becomes the outer shaping air is supplied;
a partition wall that circumferentially divides the semi-enclosed space; and
a plurality of through-holes provided in the partition wall, and
a sum of cross-sectional areas of the through-holes is greater than an opening cross-sectional area of a tip of the second air outlet.

16. The rotary atomization-type coating device according to claim 15, wherein
the air ring is formed by assembling an outer ring and an inner ring,
the partition wall is integrally formed with the inner ring, and
an elastic seal member is interposed between the partition wall and the outer ring.

17. The rotary atomization-type coating device according to claim 16, wherein a tip of the outer ring is provided at a back position of a tip of the inner ring.

18. A rotary atomization-type coating device comprising:
a bell cup having a center of rotation;
a first air outlet having an annular slit shape and provided concentrically with the center of rotation, the first air outlet blowing out inner shaping air from a back surface of the bell cup;
a second air outlet having an annular slit shape and provided concentrically with the center of rotation, the second air outlet having a larger diameter than that of the first air outlet and blowing out outer shaping air from the back surface of the bell cup; and
an air ring provided concentrically with the center of rotation to surround the bell cup, the second air outlet being formed at a tip of the air ring,
wherein
an annular slit-shaped gap between the tip of an inner circumferential surface of the air ring and a tip of the bell cup serves as the first air outlet, and
source air that becomes the inner shaping air is supplied to a semi-enclosed space between the inner circumferential surface of the air ring and the back surface of the bell cup

19. The rotary atomization-type coating device according to claim 18, wherein a ratio of an opening cross-sectional area of the first air outlet to that of the second air outlet is 3:1 to 4:1.

20. The rotary atomization-type coating device according to claim 18, wherein a flow rate of the outer shaping air is equal to or greater than that of the inner shaping air.

21. A rotary atomization-type coating device comprising:
a bell cup having a center of rotation;
a first air outlet having an annular slit shape and provided concentrically with the center of rotation, the first air outlet blowing out inner shaping air from a back surface of the bell cup; and
a second air outlet having an annular slit shape and provided concentrically with the center of rotation, the second air outlet having a larger diameter than that of the first air outlet and blowing out outer shaping air from the back surface of the bell cup,
wherein
the inner shaping air has an outward velocity component with respect to the axis of rotation,
the outer shaping air has an inward velocity component with respect to the axis of rotation, and
a flow rate of the outer shaping air is equal to or greater than that of the inner shaping air.
